(19) United States
(12) Patent Application Publication
(10) Pub. No.: US 2025/0353572 A1
(43) Pub. Date: Nov. 20, 2025

(54) Method for Operating a Drive Unit of an Electric Bicycle

(71) Applicant: Robert Bosch GmbH, Stuttgart (DE)

(72) Inventors: Gregor Goebel, Moessingen (DE); Matthias Weinmann, Balingen (DE)

(21) Appl. No.: 19/206,805

(22) Filed: May 13, 2025

(30) Foreign Application Priority Data
May 15, 2024 (DE) 10 2024 204 516.0

(51) Int. Cl. B62M 6/45; B62M 6/55

(52) U.S. Cl. CPC B62M 6/45; B62M 6/55

(57) ABSTRACT

A method for operating a drive unit of an electric bicycle is disclosed. The drive unit includes a motor and an output element and a bidirectional freewheel between the motor and the output element. The method includes (i) determining a non-output state in which the output element is in a state of being substantially free of output torque, and (ii) controlling actuation of the motor during the non-output state for opening the bidirectional freewheel into a freewheel state.

This application claims priority under 35 U.S.C. § 119 to application no. DE 10 2024 204 516.0, filed on May 15, 2024 in Germany, the disclosure of which is incorporated herein by reference in its entirety.

### BACKGROUND

The present disclosure relates to a method for operating a drive unit for an electric bicycle, as well as to an electric bicycle.

In vehicles, such as electric bikes, freewheels are known to date, which are configured so as to interrupt a connection between a driven element shaft and a motor, if the driven element runs faster than an output of the motor with respect to the forward direction of rotation, i.e. in the direction of rotation that causes the vehicle to be driven in the forward direction of travel. Often, freewheels can only open in a relative direction of rotation. However, bidirectional freewheels are also known, which can open in both relative directions of rotation. Such a bidirectional freewheel is disclosed, for example, in DE 10 2023 201702 A1.

### SUMMARY

The method according to the disclosure, having the features set forth below, is characterized in that a special operation of the drive unit can be ensured in a particularly simple and reliable manner such that a bidirectional freewheel is opened in the powertrain, i.e. in the freewheel state. According to the present disclosure, this is achieved by a method for operating a drive unit of an electric bicycle, wherein the drive unit comprises a motor and an output element and a bidirectional freewheel. The bidirectional freewheel is arranged between the motor and the output element, in particular with regard to a torque transfer. The method comprises the steps of:
determination of a non-output state in which the output element is in a state of being substantially free of output torque, and
controlled actuation of the motor during the non-output state for opening the bidirectional freewheel into a freewheel state.

In particular, an element, such as a shaft and/or gear or the like, can be considered an output element of the drive unit, at which an output torque of the drive unit can be provided. By way of the output torque, preferably via a further powertrain of the vehicle, for example via a chainring with a chain, the propulsion of the electric bicycle can occur.

Preferably, the output element can be driven by a motor torque of the motor, as well as additionally by a pedal torque of a driver of the electric bicycle. For example, a control gear can be arranged between the motor and the output element, wherein the bidirectional freewheel is preferably arranged between the control gear and the output element. For example, a crank mechanism with cranks at which the driver can generate the pedal torque can be directly connected to the output element in a torque-transmitting manner. Alternatively, preferably, the crank mechanism can be indirectly connected to the output element, for example, wherein a further freewheel can be arranged between the output element and the crank mechanism.

The bidirectional freewheel is a freewheel which can lock and release with respect to both directions of rotation. Preferably, this can occur by way of mechanical actuation of the freewheel. Preferably, the bidirectional freewheel is substantially configured as a clamp roller freewheel, in particular having a freewheel cage and a preferably mechanical actuation mechanism, wherein the freewheel mechanism and the freewheel cage can be used in particular to lock and release the freewheel.

A non-output state is one in which substantially no output torque is provided by the motor at the output element, in particular which can generate a share of a total torque to the powertrain of the electric bicycle. That is to say, in the non-output state, substantially no motor torque is generated by the motor and/or substantially no pedal torque by the operator of the electric bicycle is present. Preferably, the determination of the non-output state can be carried out by a control unit, for example, in a sensor-based manner and/or based on the operation of the motor.

In particular, a non-output state can also a state in which pedal torque of the driver is present, and not a motor torque. For example, a deactivated motor support can be present, and/or a ride of the electric bicycle at a bicycle speed above a predetermined control speed, above which the motor support is automatically deactivated, for example.

In particular, the controlled actuation of the motor during the non-output state occurs in order to generate a movement of the motor, in particular an output shaft of the motor, in a targeted manner.

In other words, in the method, an active controlled actuation of the motor occurs in a state in which no output from the drive unit of the electric bicycle occurs. This in particular initiates a rotational movement in the bidirectional freewheel, which causes the freewheel to be reliably set into the freewheel state, that is to say, to be opened, and thus to prevent torque transmission from the motor towards the output element and vice versa. That is to say, the bidirectional freewheel is opened in a targeted manner by, for example, a short-term operation of the motor in order to achieve the freewheel state.

The method thus offers the advantage that a reliable opening of the freewheel can be provided in a particularly simple manner. In particular, the method can be carried out purely in a software-based manner, for example, without additional mechanical components. In addition, the method can be carried out particularly flexibly during operation of the electric bicycle, for example before or after certain driving situations, or in particular pushing situations. The method can thus ensure in a particularly simple and reliable manner that the freewheel is reliably opened, for example for subsequent operating situations. In particular, this can prevent the motor from being undesirably dragged along by a rotation, for example of the chainring. In addition, the targeted motor-actuated opening allows for a more flexible mechanical design of the freewheel, in particular the clamping geometries of the freewheel. As a result, an optimized mechanical design of the blocking functionality can be enabled, for example, if the opening function of the freewheel is reliably ensured, whereby a particularly efficient bidirectional freewheel can be provided.

Preferred further modifications of the disclosure are set forth below.

Preferably, the controlled actuation of the motor occurs such that the motor rotates in the reverse direction of rotation. In particular, a reverse direction of rotation is a direction of rotation of the motor in which no propulsion-generating motor torque is generated. That is to say, the motor is actuated so as to operate counter to this direction of propulsion. As a result, the freewheel can be opened particularly advantageously, for example by releasing it from a clamped configuration.

Particularly preferably, the controlled actuation of the motor occurs such that, during this actuation, the motor rotates solely in the reverse direction of rotation, in particular by a corresponding controlled motor operation. That is to say, during the selective actuation of the motor causing the freewheel to open, the motor will only rotate precisely in the one direction, namely the reverse direction of rotation. Thus, in particular, in a controlled motor operation, there is a prevention of forward rotation during the selective actuation. This can particularly reliably ensure that the method leads to the opening of the bidirectional freewheel, for example, and is not affected by a temporary forward rotation of the motor.

Preferably, the determination of the non-output state comprises a detection of an end of a motor operation. In the motor operation, there is a controlled motor torque generation by the motor, in particular, which causes a propulsion of the electric bicycle. That is to say, the method detects the time at which the targeted, propulsion-causing motor torque generation is ended, wherein the controlled actuation of the freewheel in the subsequent non-output state occurs directly after this detected motor operation. As a result, in a particularly reliable manner after the end of the provision of the motor torque, the bidirectional freewheel can always be set to the open freewheel state.

Preferably, the determination of the non-output state is based on an actuation signal of the motor. In particular, the actuation signal is an electrical signal and/or an electrical current by way of which the controlled operation of the motor for generating the propulsion of the electric bicycle occurs. Particularly preferably, the non-output state is detected when the actuation signal reaches a predetermined value, for example zero. The method can thus be carried out an a particularly simple and efficient manner.

Preferably, the actuation signal is based on a pedal torque signal. In particular, a pedal torque signal is a signal that represents an instantaneous bicycle torque generated by the electric bicycle driver. For example, the pedal torque signal can be detected by way of a torque sensor. Preferably, the determination of the non-output state occurs when the pedal torque signal is equal to zero, that is to say, in particular when the driver ceases pedaling. As a result, the targeted opening of the bidirectional freewheel can be implemented in a further advantageous manner.

Particularly preferably, the method further comprises the following step: detection of the freewheel state of the bidirectional freewheel, in particular by way of a control unit. For example, the control unit can be part of the drive unit and/or the electric bicycle. That is to say, in the method, the state of the bidirectional freewheel being open is detected in a targeted manner. Preferably, the detection of the freewheel state can be sensor-based. By additional explicit detection of the freewheel state, further functions or operating states of the electric bicycle can be implemented, for example, simply and reliably as a function of the freewheel state.

Preferably, the detection of the freewheel state of the bidirectional freewheel occurs in response to a detection of a relative rotation of the motor and the output element. For example, the relative rotation can be sensor-based and/or based on a detection of an instantaneous motor torque. Thus, the freewheel state can be easily and reliably detected, and the open freewheel can be reliably provided.

Preferably, the controlled actuation of the motor occurs continuously during the non-output state for a predetermined period of time. That is to say, the motor is rotated permanently during this predetermined period of time. For example, the time period can be predefined. That is to say, when carrying out the method, the motor can always be rotated for the predetermined period of time. For example, the period of time is a maximum of 1 second, preferably a maximum of 0.5 seconds, in particular at least 0.1 seconds. As a result, it possible to implement the method in a particularly straightforward and inexpensive manner.

Further preferably, the controlled actuation of the motor during the non-output state occurs in order to rotate the motor by a predetermined angle of rotation. That is to say, the motor is rotated by a predetermined distance. For example, the predetermined angle of rotation can be at least 1 degree, preferably a maximum of 3 degrees. Preferably, the predetermined rotation of the motor about the rotation angle is monitored by way of an angle sensor of the motor. The execution of the method can thus be particularly simple and efficient.

Furthermore, the disclosure results in an electric bicycle comprising a drive unit having a motor and an output element and a bidirectional freewheel between the motor and the output element. In addition, the control unit is configured so as to carry out the described method.

### BRIEF DESCRIPTION OF THE DRAWINGS

Exemplary embodiments of the disclosure are explained in detail below with reference to the accompanying drawings. The drawing shows:

FIG. 1 a simplified schematic view of an electric bicycle in which a method to operate a drive unit of the electric bicycle according to a preferred exemplary embodiment of the disclosure is carried out,

FIG. 2 a highly simplified schematic view of a bidirectional freewheel of the electric bicycle of FIG. 1, and

FIG. 3 a highly simplified schematic view of the method according to the disclosure.

### DETAILED DESCRIPTION

Preferably, all identical components, elements, and/or units are provided with the same reference symbols in all figures.

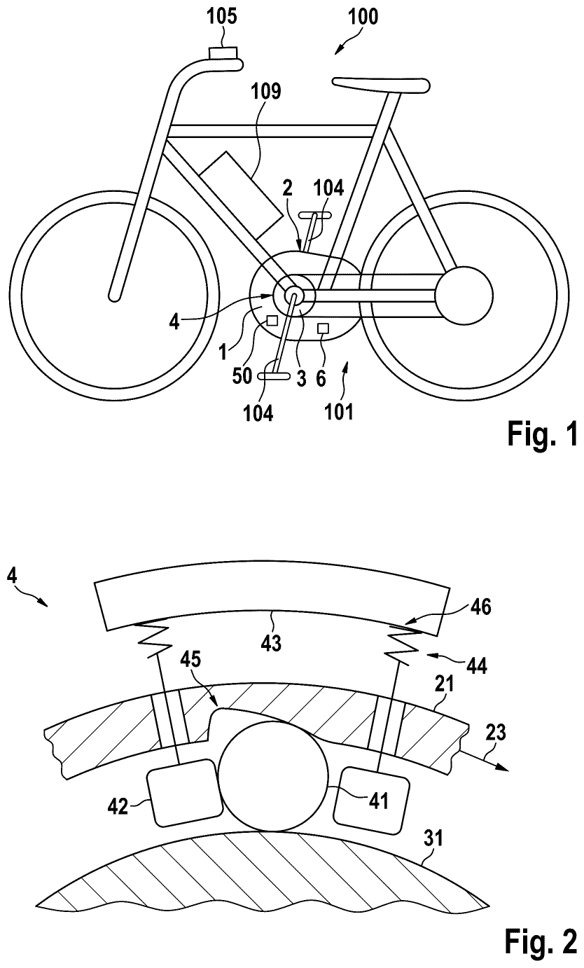

FIG. 1 shows a simplified schematic view of an electric bicycle 100 in which a method 10 to operate a drive unit 1 of the electric bicycle 100 according to a preferred exemplary embodiment of the disclosure is carried out.

The drive unit 1 comprises a motor 2, which is in particular an electric motor. The motor 2 can be supplied with electrical energy by way of an electrical energy store of the electric bicycle 100. The drive unit 1 is arranged in the region of a pedal bracket of the electric bicycle 100. A motor torque generated by the motor 2 can be used to provide motorized support for the pedal force generated by the muscle power of a rider of the electric bicycle 100. The muscle power of the rider can be applied via a crank mechanism with crank levers 104.

The drive unit 1 further comprises a control unit 50, which is configured so as to actuate the motor 2 in a controlled manner. For example, the control unit 50 can control an electrical actuation current for actuating the motor 2. In addition, the drive unit 1 comprises an output element 3 and a bidirectional freewheel 4.

The output element 3 in the illustrated exemplary embodiment is a chainring, which is part of a powertrain 101 of the electric bicycle 100 and at which all of the torque of the drive unit 1 can be transmitted to a rear wheel of the electric bicycle 100 via a bicycle chain. In detail, the motor torque and additionally the pedal torque of the operator can be provided on the output element 3.

Preferably, the output element 3 can be connected directly on the crank mechanism in a rotation-proof manner. Alternatively, for example, a further freewheel can be arranged between the crank mechanism and the output element 3.

The bidirectional freewheel 4 is arranged between the motor 2 and the output element 3 with respect to torque transmission. The freewheel drive 4 can, for example, be arranged directly adjacent to the motor 2. Alternatively, further elements, such as in particular a motor control gear, can be located between the motor 2 and the freewheel 4. Further preferably, the freewheel 4 and the output element 3 can be arranged directly adjacent to one another, or alternatively can be indirectly connected to one another via further elements.

The bidirectional freewheel 4 can cause a torque transfer between the motor 2 and the output element 3 in a blocked state. In a freewheel state, the freewheel 4 prevents the torque transfer between the motor 2 and the output element 3.

Due to the fact that the freewheel 4 is configured in a bidirectional manner, the freewheel 4 can provide the freewheel state in both relative directions of rotation.

The functionality of the bidirectional freewheel 4 is explained in the following in a simplified manner, with the aid of FIG. 2. FIG. 2 shows a highly simplified schematic detail view of the bidirectional freewheel 4 of the electric bicycle 100 of FIG. 1.

The freewheel 4 comprises a motor-side first freewheel element 21, which is connected to the motor 2 in particular in a torque-transmitting manner. In addition, the freewheel 4 comprises an output-side second freewheel element 31, which is connected to the output element 3 in a torque-transmitting manner.

The freewheel 4 is substantially configured as a clamp roller freewheel and comprises a plurality of clamp rollers 41, which are arranged between the freewheel elements 21, 31. On the radially outer first freewheel element 21, a respective clamping geometry 45 is arranged per clamp roller 41. By way of the clamping geometries 45 and the clamp rollers 41, the blocked state or the freewheel state of the freewheel 4 can be enabled by clamping or releasing the clamp rollers 41 between the freewheel elements 21, 31.

The freewheel cage 42 is arranged in the region of the clamp rollers 41 and can move or hold the clamp rollers 41 in place. Spring elements 44 connected to a fixed housing 43 of the drive unit 1 via a friction lock 46 can be used so as to cause a movement of the freewheel cage 42 in the event of a corresponding relative rotation in order to selectively actuate the clamp rollers 41, for example to hold them relative to the housing 43 or to release them from a clamped state.

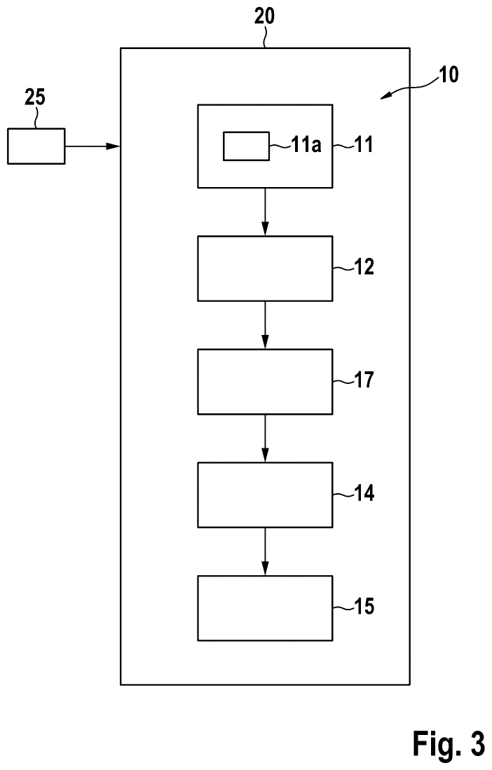

When operating the electric bicycle 100, it can occur that the bidirectional freewheel 4 is in the blocked state, whereas the freewheel state would be advantageous or desirable. In order to selectively set the freewheel 4 into the freewheel state, the method 10 according to the disclosure is provided for operating the drive unit 1, which is described below with respect to FIGS. 2 and 3.

The method 10 is preferably carried out after each operation of the motor 2 of the drive unit 1 in order to assist the propulsion of the electric bicycle 100 by way of a motor torque. In detail, when the driver stops pedaling during a forward movement of the electric bicycle 100, the propulsion-effective operation of the motor 2 is also stopped by way of the control unit 50, that is to say, in particular when a pedal torque of the driver falls to zero.

Alternatively or additionally preferably, the method 10 can also be carried out when the driver pedals but the motor support is disabled, for example automatically when the bicycle speed is above a predetermined derating speed and/or when a motor support is selectively disabled. Further alternatively or additionally preferably, the method 10 can be carried out when the driver pedals, for example with very low torque, without an engagement on the powertrain.

In the method 10, it is first determined 11 whether a non-output state is present. In the non-output state, the output element 3 is in a state of being substantially free of output torque. That is to say, there is precisely no transmission of an output torque to the powertrain 101 of the electric bicycle 100 via the output element 3.

In detail, the determination 11 of the non-output state comprises a detection 11a of an end of motor operation in which the controlled motor torque generation occurs by way of the motor 2. In particular, this is carried out based on an actuation signal based on a pedal torque signal. Alternatively, the actuation signal can also be generated based on other signals, or the like.

When the non-output state is present, then a controlled actuation 12 of the motor 2 occurs during the non-output state. The motor 2 is rotated in the reverse direction of rotation in a targeted manner. As a result, the first freewheel element 21 is rotated relative to the second freewheel element 31 on the bidirectional freewheel 4, as indicated in FIG. 2 by the arrow 23. This causes the clamp rollers 41 to be released from the clamped state, and thus the freewheel 4 is set into the freewheel state 17.

The controlled actuation of the motor 2 can occur in different ways. Particularly preferably, the motor 2 is moved in multiple pulsations, that is to say, it is moved in the reverse direction of rotation several times in succession, for a short moment each time, within a predetermined period of time. This can particularly reliably ensure the release of the clamp rollers 41 from the clamping geometries 45.

Advantageously, the controlled actuation 12 of the motor 2 takes place such that no significant rotation of the output element 3 occurs. That is to say, each movement of the motor 2 is carried out by a small amount, which does not cause significant reverse rotation.

Subsequently, in the method, a detection 14 of the freewheel state 17 of the bidirectional freewheel 4 can occur. In particular, the detection 14 of the freewheel state 17 can occur in response to a detection of a relative rotation of the motor 2 and the output element 3.

The method 10 can thereby automatically ensure, in a particularly reliable and simple manner, that the bidirectional freewheel 4 is opened after the motor operation. Through the targeted operation of the motor 2 during the non-output state, the bidirectional freewheel 4 is always reliably opened after a blocked state in order to be able to avoid undesirable torque transmissions, such as a dragging of the motor 2 during a rotation of the output element 3.

What is claimed is:

1. A method for operating a drive unit of an electric bicycle, wherein the drive unit includes a motor, an output element and a bidirectional freewheel between the motor and the output element, the method comprising:
determining a non-output state in which the output element is in a state of being substantially free of output torque, and
controlling actuation of the motor during the non-output state for opening the bidirectional freewheel into a freewheel state.

2. The method according to claim 1, wherein the controlling actuation of the motor occurs such that the motor rotates in the reverse direction of rotation.

3. The method according to claim 2, wherein the controlling actuation of the motor occurs such that the motor rotates solely in the reverse direction of rotation during the actuation by controlled motor operation.

4. The method according to claim 1, wherein the determining the non-output state comprises:
detecting an end of a motor operation in which a controlled motor torque generation occurs by way of the motor.

5. The method according to claim 1, wherein the determining the non-output state occurs based on an actuation signal of the motor.

6. The method according to claim 5, wherein the actuation signal is based on a pedal torque signal.

7. The method according to claim 1, further comprising:
detecting the freewheel state of the bidirectional freewheel.

8. The method according to claim 7, wherein the detecting the freewheel state of the bidirectional freewheel occurs in response to detecting a relative rotation of the motor and the output element.

9. The method according to claim 1, wherein the controlling actuation of the motor occurs during the non-output state for a predetermined period of time.

10. The method according to claim 1, wherein the controlling actuation of the motor during the non-output state occurs so as to rotate the motor by a predetermined angle of rotation.

11. An electric bicycle, comprising:
a drive unit having a motor, an output element and a bidirectional freewheel between the motor and output element; and
a control unit configured so as to carry out the method according to claim 1.
